(19) United States
(12) Patent Application Publication
(10) Pub. No.: US 2011/0210582 A1
(43) Pub. Date: Sep. 1, 2011

(54) VEHICLE FLOOR STRUCTURE

(75) Inventor: Takeo Mori, Shizuoka-ken (JP)

(73) Assignee: TOYOTA JIDOSHA KABUSHIKI KAISHA, Toyota-shi (JP)

(21) Appl. No.: 13/057,763

(22) PCT Filed: Nov. 16, 2009
(86) PCT No.: PCT/IB09/07459

§ 371 Date: Feb. 5, 2011

(30) Foreign Application Priority Data
Nov. 17, 2008 (JP) 2008-293346

(51) Int. Cl. B62D 25/20

(52) U.S. Cl. 296/193.07

(57) ABSTRACT

A tunnel is provided at a central portion, in the vehicle width direction, of a floor panel. The tunnel extends in a longitudinal direction of a vehicle. Along the lateral portion of the floor panel, a rocker extending in the longitudinal direction of the vehicle is provided. A floor crossmember is spanned between the tunnel and the rocker. The floor crossmember is composed of a first floor crossmember and a second floor crossmember. A fragile portion is formed at a fitting portion between the first floor crossmember and the second floor crossmember. The fragile portion F is disposed at a position closer to a lateral center position of the floor panel than a lateral portion of the floor panel.

### BACKGROUND OF THE INVENTION

1. Field of the Invention

The invention relates to a vehicle floor structure.

2. Description of the Related Art

As shown in FIG. 7, in a conventional vehicle floor structure a rocker 52 that extends along the longitudinal direction of a vehicle is provided at a side portion of the floor panel 51, and a floor crossmember 53 is provided beside the rocker 52. One end of the floor crossmember 53 is fixed to the rocker 52, and the bottom of the floor crossmember 53 (a counter rocker-side end of the floor crossmember 53) is fixed to the floor panel 51. In addition, a center pillar 54 is mounted on the lateral face (outer face) of the rocker 52, which is located on the opposite side of the rocker 52 from that where the floor crossmember 53 is provided.

Generally, it is desirable to prevent the center pillar from buckling in the event of a side collision of the vehicle. However, in the vehicle floor structure shown in FIG. 7, the floor crossmember 53 is entirely fixed to a floor surface. Thus, in the event of a side collision, deformation of the floor crossmember 53 is minimal, and the floor crossmember 53 is deformed at a position close to the rocker 52. As a result, it is difficult to prevent the rocker 52 from buckling. Thus, there is a problem in that the center pillar 54 is likely to buckle together with the rocker 52.

To cope with this problem, a lower vehicle body structure that prevents a center pillar from buckling in the event of a side collision of the vehicle is described, for example, in Japanese Patent No. 2868626 (JP-2868626). In the described lower vehicle body structure, a tunnel that extends in the longitudinal direction of the vehicle is provided at a central portion of a floor surface. A floor crossmember is composed of an outer member and an inner member, and the outer member is fixed to a floor panel. Further, an energy absorption member is disposed between the outer member and the tunnel, and the floor panel is provided inward of the outer member (i.e., on a center side in the lateral direction of the vehicle), with a deformation portion that is deformed by a load input by the side collision. With this structure, the outer member is prevented from buckling in the event of a side collision, thereby reducing the amount of intrusion of the center pillar into a vehicle interior.

However, in the lower vehicle body structure for the vehicle described in JP-2868626, the floor crossmember has a generally U-shaped cross-section that opens downward. Flanges are formed at the lower edges of the outer member in the longitudinal direction of the vehicle respectively. These flanges are connected to a top face of the floor panel, thus forming a closed cross-sectional structure that extends in the vehicle width direction. Thus, in the event of a side collision, the impact load from a side face diagonally diffuses to an impact surface side through the floor panel without reaching a fragile portion. Consequently, it is difficult to prevent the rocker from buckling. Accordingly, there is a problem in that the buckling amount of the rocker is large and the amount of intrusion of the center pillar into the vehicle interior is large.

### SUMMARY OF THE INVENTION

The invention provides a vehicle floor structure reduces the buckling amount of a rocker in the event of a side collision of a vehicle to thereby reduce the amount of intrusion of a center pillar into a vehicle interior.

A first aspect of the invention relates to a vehicle floor structure that includes a rocker disposed at a lateral portion of a vehicle floor surface and extends in a longitudinal direction of the vehicle. This floor structure is characterized by being equipped with a floor crossmember that extends in a lateral direction of the vehicle and that is disposed inward of the rocker in the lateral direction of the vehicle, wherein the floor crossmember extends to a lateral center position of the vehicle floor surface beyond an intermediate position between the lateral center position of the vehicle floor surface and the lateral portion of the vehicle floor surface, and a fragile portion is formed in the floor crossmember at a position closer to the lateral center position of the vehicle floor surface than the lateral portion of the vehicle floor surface.

According to the aforementioned floor structure, the floor crossmember extends to the lateral center position of the vehicle floor surface beyond the intermediate position between the lateral center position of the vehicle floor surface and the lateral portion of the vehicle floor surface, and the fragile portion formed in the floor crossmember. It should be noted herein that the fragile portion is formed in the floor crossmember at the position closer to the lateral center position of the vehicle floor surface than the lateral portion of the vehicle floor surface. Thus, when the fragile portion is destroyed, the downward movement of a counter rocker-side end of the floor crossmember is reduced. As a result, the buckling amount of the rocker in the event of a side collision of the vehicle can be made small, and the amount of intrusion of the center pillar into the vehicle interior can be made small.

In the foregoing aspect of the invention, a top face of the floor crossmember may be horizontal, and an arch may be formed at a lower edge of the floor crossmember.

According to the aforementioned construction, the top face of the floor crossmember is horizontal. Therefore, the floor crossmember is supported rectilinearly. As a result, the rigidity against a load applied as a result of a side collision can be increased. Further, the arch is formed at the lower edge of the floor crossmember. Thus, an impact load resulting from a side collision can be prevented from diagonally diffusing to an impact surface side through the floor surface. As a result, the load can be efficiently transmitted to the fragile portion. Accordingly, the buckling amount of the rocker in the event of a side collision of the vehicle can be made small, and the amount of intrusion of the center pillar into the vehicle interior can be made small.

Further, in the above configuration, a tunnel that extends in the longitudinal direction of the vehicle may be provided at the lateral center position of the vehicle floor surface, and the floor crossmember may be spanned between the rocker and the tunnel.

According to the above configuration, the floor crossmember is spanned between the rocker and the tunnel. Thus, the floor crossmember can be disposed with ease.

Further, in the foregoing aspect of the invention, the fragile portion may be a notch or an opening formed through the floor crossmember. Further, in the foregoing aspect of the invention, the floor crossmember may be composed of a first floor crossmember and a second floor crossmember that are continuously connected to each other in a length direction, the fragile portion may be formed between the first floor crossmember and the second floor crossmember, and the first floor crossmember and the second floor crossmember may have cross-sections whose thicknesses are different from each other. Furthermore, in the foregoing aspect of the invention, the floor crossmember may be composed of a first floor crossmember, a second floor crossmember, and a fragile member disposed between the first floor crossmember and the second floor crossmember, and the fragile member may be made of a material that is lower in strength than the first floor crossmember and the second floor crossmember.

As described above, the fragile portion can be formed, for example, as the notch portion or the opening, through a difference in thickness between the cross-section of the first floor crossmember and the cross-section of the second floor crossmember, or from a material low in strength.

Further, in the aforementioned construction, the fragile portion may be formed at such a position that the floor crossmember is bent downward when being bent through the input of a force to the floor crossmember from the rocker side.

According to the aforementioned construction, the fragile portion is formed at such a position that the floor crossmember is bent downward when being bent through the input of a force to the floor crossmember from the rocker side. The bent floor crossmember can thereby be prevented from protruding upward.

Furthermore, a second aspect of the invention relates to a vehicle floor structure that includes a rocker disposed at a lateral portion of a vehicle floor surface and extends in a longitudinal direction of the vehicle, and a center pillar provided above the rocker. This floor structure is characterized by being equipped with a plurality of floor crossmembers that are disposed inward of the rocker and extend in a lateral direction of the vehicle, wherein a central floor crossmember, which is the floor crossmember of the plurality of floor crossmembers, is disposed at a position close to the center pillar and a joint between the central floor member and the vehicle floor surface is shorter in the lateral direction of the vehicle than a joint between the plurality of the floor crossmembers other than the central floor member and the vehicle floor surface.

According to the aforementioned construction, the joint region of the central floor crossmember, which is disposed at the position close to the center pillar, to the floor surface is shorter in length in the lateral direction, of the vehicle than the joint region of the edge-side floor crossmember, which is disposed at the position far from the center pillar, to the floor surface. Thus, in the event of a side collision of the vehicle, the central floor crossmember is deformed more inward in the lateral direction than the edge-side floor crossmember. Thus, the central floor crossmember can be deformed more than the edge-side floor crossmember. Therefore, the rocker can be easily prevented from buckling.

In the aforementioned construction, an arch may be formed along a lower edge of the central floor crossmember, and the arch may assume such a shape as to increase in distance from the vehicle floor surface with increases in distance from the joint region between the vehicle floor surface and the central floor crossmember.

According to the aforementioned construction, the central floor crossmember has the arch formed along a lower edge thereof. Thus, an impact load resulting from a side collision can be prevented from diagonally diffusing to an impact surface side through the vehicle floor surface. As a result, the load can be efficiently transmitted to the fragile portion. Accordingly, the buckling amount of the rocker in the event of a side collision of the vehicle can be made small, and the amount of intrusion of the center pillar into a vehicle interior can be made small.

The vehicle floor structure according to the invention allows a reduction in buckling amount of the rocker in the event of a side collision of the vehicle and a reduction in amount of intrusion of the center pillar into the vehicle interior.

### BRIEF DESCRIPTION OF THE DRAWINGS

The foregoing and further features and advantages of the invention will become apparent from the following description of example embodiments with reference to the accompanying drawings, wherein like numerals are used to represent like elements and wherein:

FIG. 1 is a perspective view of a main part of the vehicle floor structure according to the first embodiment of the invention;

FIG. 2 is a lateral view of a floor crossmember;

FIG. 3A is a schematic lateral view showing the vehicle floor structure according to the first embodiment of the invention when a side collision occurs, and FIG. 3B is a schematic lateral view showing the vehicle floor structure according to the related art when a side collision occurs;

FIGS. 4A and 4B are both lateral views showing other variations of the floor crossmember;

FIGS. 5A and 5B are both lateral views showing still other variations of the floor crossmember;

FIG. 6 is a plan view of a vehicle floor structure according to the second embodiment of the invention; and

FIG. 7 is a perspective view of a main part of a vehicle floor structure according to the related art.

### DETAILED DESCRIPTION OF EMBODIMENTS

The embodiments of the invention will be described hereinafter with reference to the accompanying drawings. In describing the drawings, like elements are denoted by like reference symbols, and the same description is omitted. Further, for the sake of convenience in drawing the elements, the dimensional ratios in the drawings do not necessarily coincide with those described below.

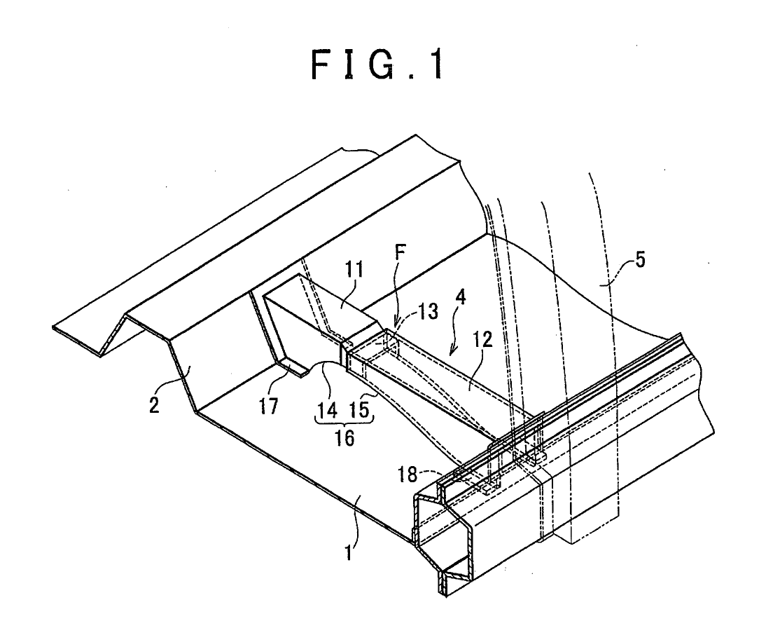

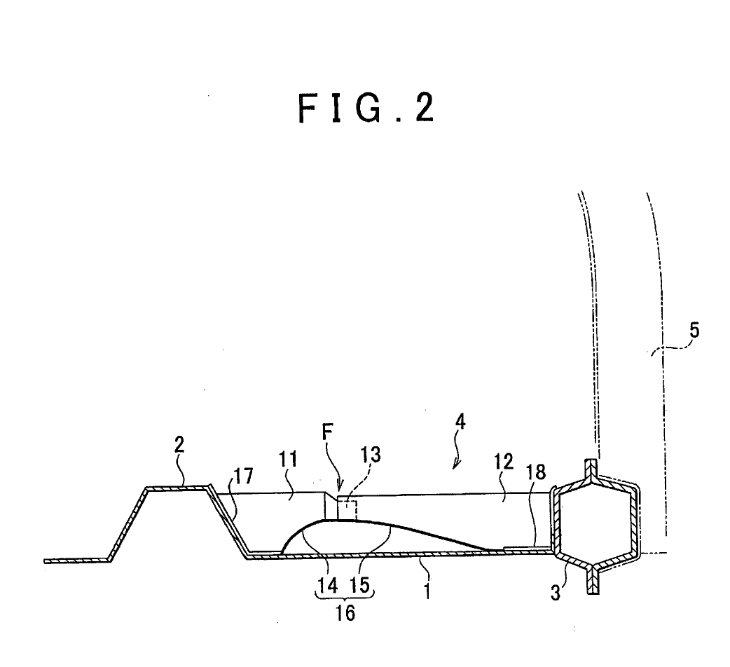

FIG. 1 is a perspective view of a vehicle floor structure according to the first embodiment of the invention, and FIG. 2 is a lateral view of a floor crossmember. As shown in FIGS. 1 and 2, the vehicle floor structure according to this embodiment of the invention includes floor panel 1. The floor panel 1 serves as a floor surface of the vehicle. The floor panel 1 includes a tunnel 2, provided at a central portion of the floor panel 1 in a vehicle width direction, and a rocker 3, provided at a lateral edge of the floor panel 1. Both the tunnel 2 and the rocker 3 extend in the longitudinal direction of the vehicle.

The tunnel 2 is formed by deforming part of the floor panel 1. Further, the rocker 3 is a frame member with a generally polygonal cross-section. In addition, a floor crossmember 4 is spanned between the tunnel 2 and the rocker 3. Thus, the floor crossmember 4 extends to a lateral center position of the floor panel 1 beyond an intermediate portion between the tunnel 2 provided at a lateral center position of the floor panel 1 and the rocker 3 provided at a lateral portion of the floor panel 1. The floor crossmember 4 is composed of a first floor crossmember 11 disposed on the tunnel 2 side and a second floor crossmember 12 disposed on the rocker 3 side.

Both the first floor crossmember 11 and the second floor crossmember 12 are generally have a U-shaped cross-section. The cross-sectional area of the first floor crossmember 11 is larger than that of the second floor crossmember 12. Further, both the first floor crossmember 11 and the second floor crossmember 12 extend in the vehicle width direction, and extend in their respective length directions.

Furthermore, a fitting portion 13 is formed at the end of the first floor crossmember 11 that points toward the rocker 3 side. The fitting portion 13 is generally U-shaped in cross-section. The fitting portion 13 has a smaller cross-section than the second floor crossmember 12. The fitting portion 13 of the first floor crossmember 11 is fitted to the end of the second floor crossmember 12 near the tunnel 2 side. Thus, the first floor crossmember 11 is joined to the second floor crossmember 12. A joint between the first floor crossmember 11 and the second floor crossmember 12 is a fragile portion F that has lower strength and is more fragile than other regions of the floor crossmember 4. The fragile portion F is formed at a position nearer the lateral center of the floor panel 1 than the lateral portion of the floor panel 1 (i.e., the end of the floor crossmember 4 located on the rocker side). It should be noted that, as shown in FIGS. 1 and 2, the fragile portion F is formed at a position closer to the lateral center position of the floor panel 1 than an intermediation portion of the crossmember 4 in a lengthwise direction thereof.

Further, as shown in FIG. 2, both upper edges of lateral faces of the first floor crossmember 11 and the second floor crossmember 12 are horizontal, and top faces of the first floor crossmember 11 and the second floor crossmember 12 are horizontal faces. The cross-sectional area of the first floor crossmember 11 is larger than that of the second floor crossmember 12. Therefore, a step is formed at the joint between the first floor crossmember 11 and the second floor crossmember 12 in the floor crossmember 4. Furthermore, a first semi-arch 14 and a second semi-arch 15 are formed in the lower edges of the lateral face of the first floor crossmember 11 and the second floor crossmember 12, respectively.

When the first floor crossmember 11 is joined to the second floor crossmember 12 and an arch 16 is formed along the lower edge of a lateral face of the floor crossmember 4. Accordingly, the central portion of the floor crossmember 4 in the lengthwise direction is separated from the floor panel 1.

Further, the arch 16 assumes such a shape as to increase in distance from the floor panel 1 with increases in distance from the end of the floor crossmember 4. In addition, flanges 17 and 18 are formed at the opposite ends of the floor crossmember 4. The floor crossmember 4 is welded to the floor panel 1, the tunnel 2, and the rocker 3 via the flanges 17 and 18.

A center pillar 5 is mounted on the rocker 3 at an outer lateral portion of the rocker 3 at a position corresponding to the position of the floor crossmember 4. The center pillar 5 is securely welded to the outer face and the top face of the rocker 3.

Next, the operation of the vehicle floor structure according to this embodiment of the invention will be described.

In the event of a side collision of the vehicle equipped with the vehicle floor structure according to this embodiment of the invention, the force is applied downward on the rocker 3 from above, and the rocker 3 is about to buckle. It should be noted herein that when the buckling amount of the rocker 3 is large, the amount of intrusion of the center pillar 5 into the vehicle interior is large. Therefore, it is desirable to minimize the buckling amount of the rocker 3.

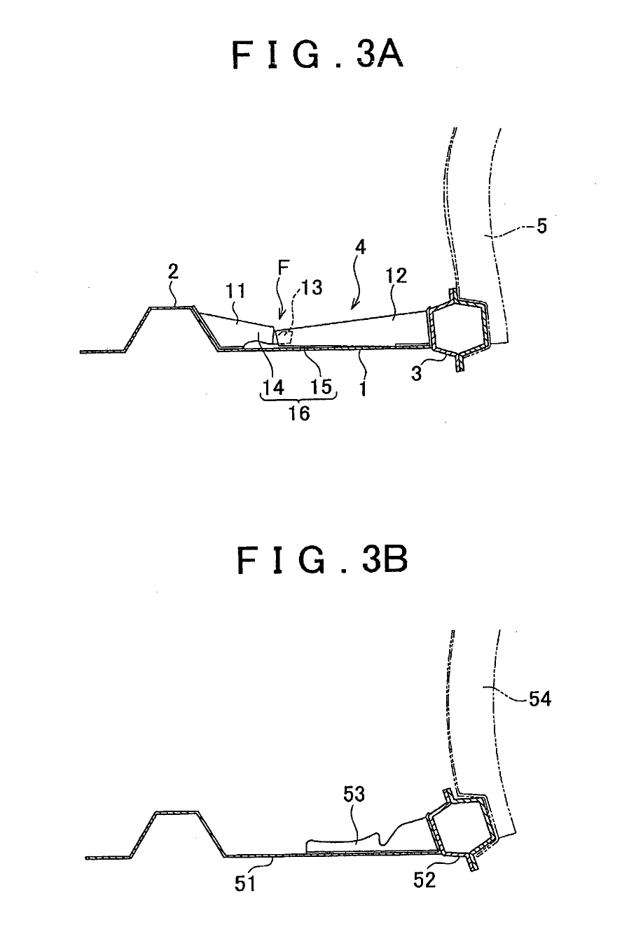

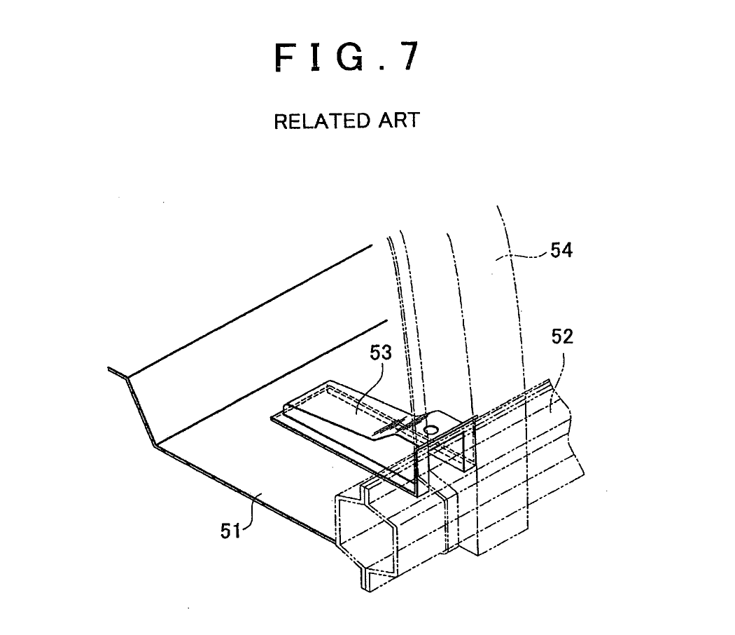

It should be noted herein that the floor crossmember 53 shown in FIG. 7 is fixed at the counter rocker-side end of the floor crossmember 53 (the bottom of the floor crossmember 53) to the floor panel 51. Thus, as shown in FIG. 3B, in the event of a side collision of the vehicle, the buckling amount of the rocker 52 becomes large. As a result, the amount of intrusion of the center pillar 54 into the vehicle interior becomes large.

In this respect, in the vehicle floor structure according to this embodiment of the invention, a fragile portion F is formed between and joins the first floor crossmember 11 to the second floor crossmember 12 in crossmember 4. The fragile portion F joining the first floor crossmember 11 to the second floor crossmember 12 is destroyed in the event of a side collision of the vehicle. In this case, the floor crossmember 4 according to this embodiment of the invention has the fragile portion F formed at a position closer to the lateral center position of the floor panel 1 than the lateral portion of the floor crossmember 4. Thus, as shown in FIG. 3A, even if the fragile portion F is destroyed, the downward movement of the end of the second floor crossmember 12 on the tunnel 2 side is minimized. Accordingly, even in the event of a side collision of the vehicle, the buckling amount of the rocker 3 may be reduced.

Further, in the vehicle floor structure according to this embodiment of the invention, the arch 16 is formed along the lower edge of the lateral side face of the floor crossmember 4, and part of the floor crossmember 4 is separated from the floor panel 1. Thus, an impact load input by a side collision can be prevented from diagonally diffusing to an impact surface side through the floor panel 1. As a result, the load may be efficiently transmitted to the fragile portion F. Accordingly, the buckling amount of the rocker 3 in the event of a side collision may be reduced, thereby reducing the amount of intrusion of the center pillar 5 into the vehicle interior.

Furthermore, in the vehicle floor structure, the floor crossmember 4 is spanned between the tunnel 2 and the rocker 3. Thus, the floor crossmember 4 can be disposed with ease. Further, in the vehicle floor structure according to this embodiment of the invention, the first floor crossmember 11 and the second floor crossmember 12 have a generally U-shaped cross-section opening downward, and the cross-sectional area of the first floor crossmember 11 is larger than that of the second floor crossmember 12. Thus, in the event of a side collision of the vehicle, the second floor crossmember 12 moves under the first floor crossmember 11, and the floor crossmember 4 is bent downward. Thus, in the event of a side collision of the vehicle, the floor crossmember 4 is prevented from protruding upward.

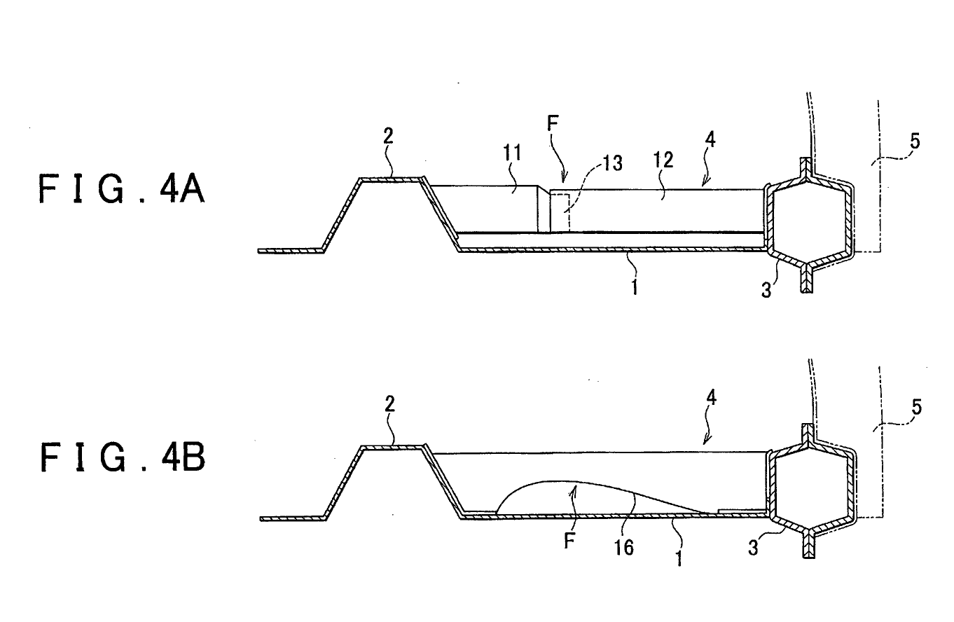

Next, alternative configurations of the vehicle floor structure according to the first embodiment of the invention, especially other configuration of the floor crossmember 4 will be described. FIGS. 4A and 4B are views showing other configurations of the floor crossmember. In the configuration shown in FIG. 4A, a step portion is formed between the top faces of the first floor crossmember 11 and the second floor crossmember 12 in crossmember 4. The step portion serves as the fragile portion F. In addition, the floor crossmember 4 has no curved portion formed in the lower face side thereof, and is designed to be rectilinear. It should be noted that the lower edge of the lateral side face of the floor crossmember 4 is separated from the floor panel 1.

Alternatively, the configuration shown in FIG. 4B can also be adopted. In the configuration shown in FIG. 4B, the floor crossmember 4 is constructed as an integral member, and the top face of the floor crossmember 4 is flat. On the other hand, the arch 16 is formed in the lower face of the floor crossmember 4. In this configuration, a reduced diameter region of the arch 16 serves as the fragile portion F.

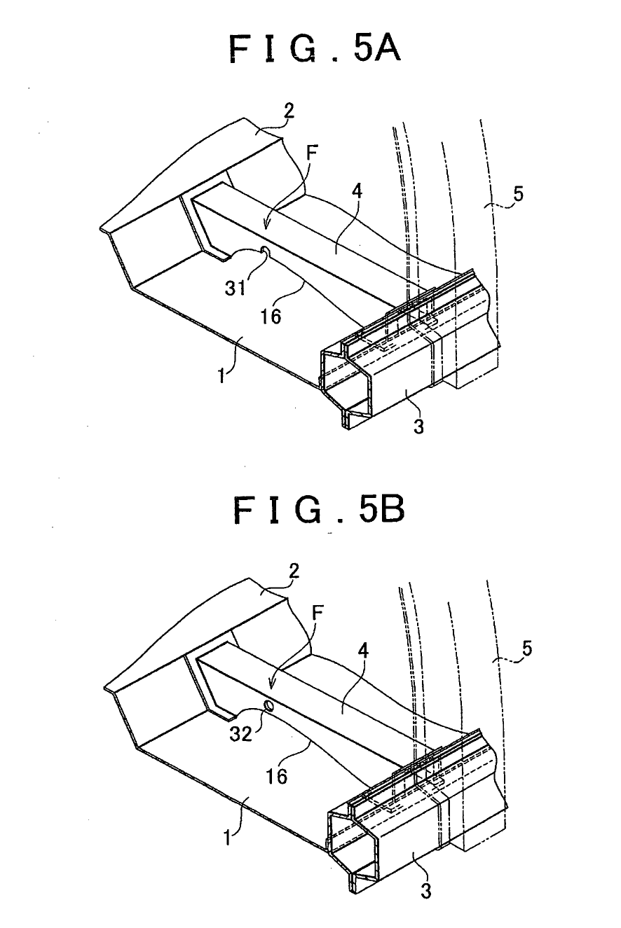

Other variations of the fragile portion are shown in FIGS. 5A and 5B. In the example shown in FIG. 5A, a notch portion 31 is formed in the floor crossmember 4 at the lower edge of the lateral side face of the floor crossmember 4. This notch portion 31 serves as the fragile portion F. Further, in the example shown in FIG. 5B, an opening 32 is formed through the lateral face of the floor crossmember 4. The opening 32 serves as the fragile portion F. It should be noted, as shown in FIGS. 5A and 5B, that the fragile portion F is formed closer to the lateral center position of the floor panel 1 than an intermediate portion of the floor crossmember 4 in a lengthwise direction thereof. In the event of a side collision of the vehicle, the floor crossmember 4 is destroyed first from the notch portion 31 or opening 32.

Another variation of the fragile portion may be, for example, a groove may be formed on the top face of the floor crossmember 4. Alternatively, a connecting member made of a material lower in strength than the first floor crossmember 11 and the second floor crossmember 12 may be interposed between a joint portion of the first floor crossmember 11 and a joint portion of the second crossmember 12.

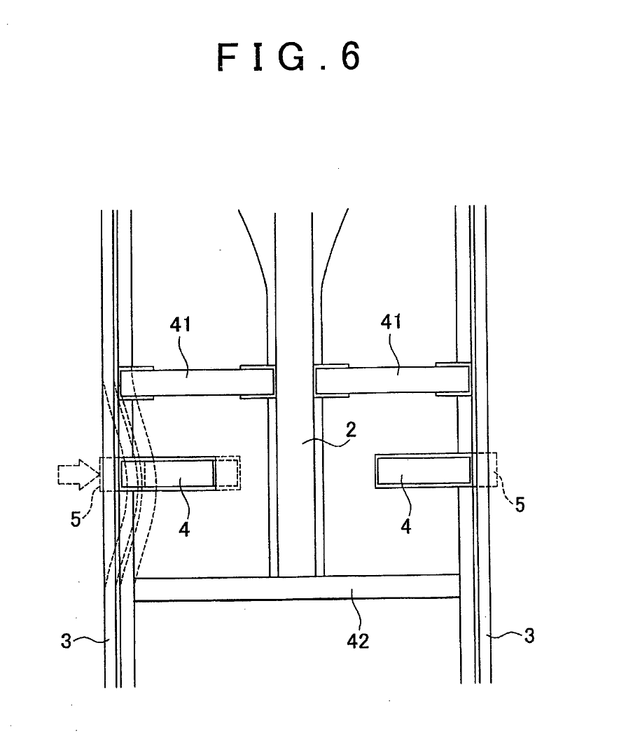

Next, the second embodiment of the invention will be described. FIG. 6 is a plan view of a vehicle floor structure according to the second embodiment of the invention. As shown in FIG. 6, in the vehicle floor structure according to this embodiment of the invention, the floor panel 1 includes a tunnel 2, provided at a central portion of the floor panel 1 in a vehicle width direction on a top side, and rockers 3, provided at the lateral portions of the floor panel 1. Both the tunnel 2 and the rocker 3 extend in the longitudinal direction of the vehicle.

Further, the rockers 3 are provided with floor crossmembers 4 respectively, and front floor crossmembers 41 and a rear floor crossmember 42 are provided in front of and behind the floor crossmembers 4 respectively. The floor crossmembers 4 are disposed on both sides of the floor panel 1, namely, on right and left sides of the floor panel 1 respectively, and are disposed between the rockers 3 and the tunnel 2 respectively.

The floor crossmembers 4 are securely welded to the floor panel 1 at positions in the vicinity of both lateral ends of the vehicle respectively. As with the first embodiment, an arch is so formed in a lengthwise central portion of each of the floor crossmembers 4 as to increase in spacing distance from the floor panel 1 with increases in spacing distance from a welding region.

Furthermore, the front floor crossmembers 41 are disposed on both the sides of the floor panel 1, namely, on the right and left sides of the floor panel 1 respectively, and are spanned between the rockers 3 and the tunnel 2 respectively. It should be noted herein that each of the front floor crossmembers 41 extends towards the center of the floor panel 1 beyond a corresponding one of the floor crossmembers 4 on the center side of the floor panel 1.

Further, the tunnel 2 provided in the floor panel 1 extends in the longitudinal direction of the vehicle to a position before the location of the rear floor crossmember 42. The rear floor crossmember 42 is spanned between the right and left rockers 3 on the top face of the floor panel 1.

The front floor crossmembers 41 and the rear floor crossmember 42 have flanges formed over entire length regions thereof on the lower face sides thereof respectively, and are welded to the floor panel 1 via the flanges respectively. Accordingly, the length of the welds joining the floor crossmembers 4 to the floor panel 1 is shorter than the length of the weld in the front floor crossmembers 41 and the rear floor crossmember 42. In this embodiment, the floor crossmembers 4 are central floor crossmembers, and the front floor crossmembers 41 and the rear floor crossmember 42 are edge-side floor crossmembers.

In the vehicle floor structure according to the embodiment of the invention described above, the joints between the floor crossmembers 4 and the floor panel 1 are shorter in the lateral direction of the vehicle than the respective joints between the front floor crossmembers 41 and rear floor crossmembers 42 with the floor panel. In this case, if the vehicle undergoes a side collision, the floor crossmembers 4 are deformed more inward in the lateral direction than the front floor crossmembers 41 and the rear floor crossmember 42. Thus, the floor crossmembers 4 are deformed more than the front floor crossmember 41 and the rear floor crossmember 42. Therefore, buckling of the rockers 3 may be significantly reduced.

Although example embodiments of the invention have been described above, the invention should not be limited to the described embodiments. For example, in each embodiment of the invention, the floor crossmember 4 is spanned between the tunnel 2 and the rocker 3. However, the floor crossmember 4 may be spanned between the floor panel 1 and the rocker 3 instead of being spanned between the tunnel 2 and the rocker 3. Further, in the second embodiment of the invention, the front floor crossmember 41 and the rear floor crossmember 42 are provided. However, the front floor crossmember 41 or the rear floor crossmember 42 may be individually, or additional floor crossmembers may be provided.

1-14. (canceled)

15. A vehicle floor structure that includes a rocker disposed at a lateral portion of a vehicle floor surface and extending in a longitudinal direction of the vehicle, the vehicle floor structure comprising:
a floor crossmember that extends in a lateral direction of the vehicle and that is disposed inward of the rocker in the lateral direction of the vehicle, wherein the floor crossmember extends to a lateral center position of the vehicle floor surface beyond an intermediate position between the lateral center position of the vehicle floor surface and the lateral portion of the vehicle floor surface; and
a fragile portion is formed in the floor crossmember at a position closer to the lateral center position of the vehicle floor surface than the lateral portion of the vehicle floor surface, wherein
an arch is formed along a lower edge of the floor crossmember; and
the arch assumes such a shape as to increase in distance from the vehicle floor surface with increase in distance from the joint between the vehicle floor surface and the floor crossmember.

16. The floor structure according to claim 15, wherein a top face of the floor crossmember is horizontal.

17. The floor structure according to claim 15, further comprising:
a tunnel fanned at the lateral center position of the vehicle floor surface that extends in the longitudinal direction of the vehicle, wherein
the floor crossmember is spanned between the rocker and the tunnel.

18. The floor structure according to claim 15, wherein the fragile portion is a notch.

19. The floor structure according to claim 18, wherein the notch is formed in a lower edge of a lateral face of the floor crossmember.

20. The floor structure according to claim 15, wherein the fragile portion is an opening formed through the floor crossmember.

21. The floor structure according to claim 20, wherein the opening is formed through a lateral face of the floor crossmember.

22. The floor structure according to claim 15, wherein:
the floor crossmember comprises a first floor crossmember and a second floor crossmember that are connected to each other in a length direction;
the fragile portion is formed between the first floor crossmember and the second floor crossmember; and
the first floor crossmember has a cross-sectional area that differs from that of the second floor crossmember.

23. The floor structure according to claim 22, wherein:
the first floor crossmember is connected to a lateral center position of the vehicle floor surface;
the second floor crossmember is connected inward of the rocker in the lateral direction of the vehicle; and
the cross-sectional area of the first floor crossmember is larger than the cross-sectional area of the second floor crossmember.

24. The floor structure according to claim 15, wherein:
the floor crossmember is composed of a first floor crossmember, a second floor crossmember, and a fragile member disposed between the first floor crossmember and the second floor crossmember; and
the fragile member is made of a material that has a lower strength than the first and second floor crossmembers.

25. The floor structure according to claim 15, wherein the fragile portion is formed at such a position that the floor crossmember is bent downward when being bent through input of a force to the floor crossmember from the rocker side.

26. The floor structure according to claim 15, wherein the fragile portion is formed at a position closer to a laterally intermediate position side of the floor surface than an intermediate position of the floor crossmember in a length direction.

27. A vehicle floor structure that includes a rocker disposed at a lateral portion of a vehicle floor surface and extending in a longitudinal direction of the vehicle, and a center pillar provided above the rocker, the vehicle floor structure comprising:
a plurality of floor crossmembers that are disposed inward of the rocker and extend in a lateral direction of the vehicle, wherein a central floor crossmember, which is the floor crossmember of the plurality of floor crossmembers, is disposed at a position close to the center pillar; and
a joint between the central floor member and the vehicle floor surface is shorter in the lateral direction of the vehicle than a joint between the plurality of the floor crossmembers other than the central floor crossmember and the vehicle floor surface, wherein
an arch is formed along a lower edge of the central floor crossmember; and
the arch assumes such a shape as to increase in distance from the vehicle floor surface with increases in distance from the joint between the vehicle floor surface and the central floor crossmember.
